(19) United States
(12) Patent Application Publication
(10) Pub. No.: US 2007/0158410 A1
(43) Pub. Date: Jul. 12, 2007

(54) Employer notification system

(76) Inventor: Jorge Bustamante, Irving, TX (US)

Correspondence Address: Mr. Christopher John Rourk;Jackson Walker LLP, 901 Main Street, Suite 6000, DALLAS, TX, 75202, US

(21) Appl. No.: 11/331,285

(22) Filed: Jan. 12, 2006

(51) Int. Cl. G06K 5/00; G06K 7/10

(52) U.S. Cl. 235/380; 235/377

(57) ABSTRACT

An apparatus for monitoring employees is provided. The apparatus includes a biometric sensor generating biometric data, such as a fingerprint reader, and time of measurement data. An identification system receives the biometric data and determines a personal identifier, such as an employee's name, based on the biometric data. An employer notification system generates a notification message that includes the employee's name and the time that they clocked in. A notification message transmission system determines the best way to get the notification message to the employer, such as by checking an employer notification profile.

### FIELD OF THE INVENTION

The present invention pertains to the field of monitoring employee attendance, and more particularly to a system and method for notifying an employer when an employee has arrived at work.

### BACKGROUND OF THE INVENTION

Systems and methods for monitoring employees are known in the art. Such systems and methods require employees to “punch in” when they arrive at work and to “punch out” when they leave, such as by making an appropriate entry into a computerized workstation, by placing a card in a time-stamping device, or in other manners.

While such monitoring systems are useful, they are subject to abuse. For example, it is possible for an employee to “punch in” or “punch out” for another employee, so as to cover for an employee that is late getting to work, that leaves early, or that simply does not show up for work. While biometric sensors have recently been combined with such monitoring systems so as to make it more difficult to abuse such systems in this manner, there are still problems associated with these systems that make it difficult to ensure that employees are not only present at work, but that they are also at their work location and actively working.

### SUMMARY OF THE INVENTION

In accordance with the present invention, a system and method for monitoring employees are provided that overcome known problems with monitoring employees.

In particular, a system and method for monitoring employees are provided that allow employers to be notified when an employee has checked into work.

In accordance with an exemplary embodiment of the present invention, an apparatus for monitoring employees is provided. The apparatus includes a biometric sensor generating biometric data, such as a fingerprint reader, and time of measurement data. An identification system receives the biometric data and determines a personal identifier, such as an employee's name, based on the biometric data. An employer notification system generates a notification message that includes the employee's name and the time that they clocked in. A notification message transmission system determines the best way to get the notification message to the employer, such as by checking an employer notification profile.

The present invention provides many important technical advantages. One important technical advantage of the present invention is a system that alerts an employer when an employee has clocked into work, such as by verifying employee identity using a biometric scanning device and transmitting a message to the employer when the employee's identification has been verified.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for notifying an employer upon confirmation of biometric employee data in accordance with an exemplary embodiment of the present invention;

FIG. 2 is a flowchart of a method for monitoring employees in accordance with an exemplary embodiment of the present invention; and

FIG. 3 is a diagram of a system for monitoring employee attendance in accordance with an exemplary embodiment of the present invention.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

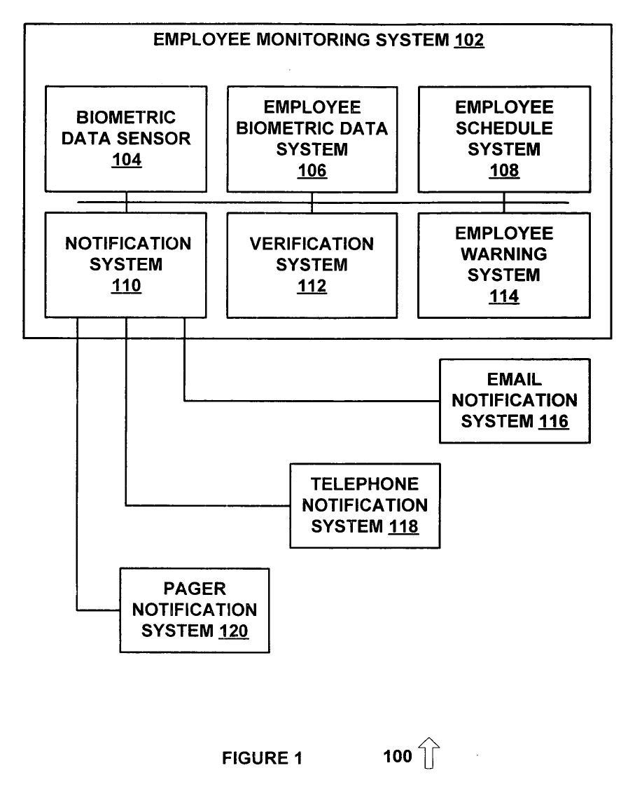

FIG. 1 is a diagram of a system 100 for notifying an employer upon confirmation of biometric employee data in accordance with an exemplary embodiment of the present invention. System 100 allows employers to receive notification, such as an e-mail or a voice message, after an employee has checked in to work.

System 100 includes employee monitoring system 102, which can be implemented in the hardware, software, or a suitable combination of hardware and software, and which can include one or more software systems operating on a general purpose processing platform. As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Employee monitoring system 102 includes biometric data sensor 104, employee biometric data system 106, employee schedule system 108, notification system 110, verification system 112, and employee warning system 114. Biometric data sensor 104 is a suitable biometric data sensor for reading biometric data from a person so as to allow the identity of the person to be verified. In one exemplary embodiment, biometric data sensor 104 can be a finger print reader, a retinal scan reader, a voice identification reader, or other suitable biometric data sensors. Biometric data sensor 104 receives the input from a person such as a fingertip for scanning, a retinal image for scanning, a voice sample, or other suitable biometric data, and outputs digitized data that characterizes relevant portions of the biometric data for authentication and verification against a database of employee biometric data. Biometric data sensor 104 can also generate time data associated with the time a biometric measurement is made.

Employee biometric data system 106 stores one or more types of biometric data for employees, such as fingerprint data, retinal scan data, voice print data, or other suitable biometric data. Employee biometric data system 106 can further receive biometric data generated by biometric data sensor 104 and can determine whether the data from biometric data sensor 104 corresponds to an employee biometric data set stored in employee biometric data system 106. Employee biometric data system 106 can output the identity of the employee matching the biometric data sensor, the absence of a suitable match, or other suitable data.

Employee schedule system 108 stores employee schedule data, such as the time and dates when an employee should be present at work. Employee schedule system 108 can also store data reflecting when an employee arrived, whether an employee was late, the number of times the employee has been late, whether an employee has been absent, whether the absences have been excused, whether the employee has failed verification, and other suitable data.

Notification system 110 stores notification data for employees and employers and can generate suitable notification data in response to data received from employee biometric data system 106, employee schedule system 108, verification system 112, and employee warning system 114. In one exemplary embodiment, notification system 110 can receive a notification for an employer and can determine the proper location or means for contacting the employer. For example, an employer can store a schedule indicating that for certain periods of the day the employer should be paged with notifications, at other periods of the day that the employer should receive a telephone notification through telephone notification system 118, and that at other periods of the day the employer should receive e-mail notification through e-mail notification system 116. Likewise, an employer may receive all notifications through only one system, or may indicate periods of the day when notification should not be transmitted. Likewise, notification system 110 can store employee contact data, such as to notify an employee that they are late for work and to request the employee to provide a reason or otherwise indicate whether they are planning on attending work on that day.

Verification system 112 periodically prompts employees to re-enter biometric data through biometric data sensor 104 or other suitable means. In one exemplary embodiment, verification system 112 can prompt an employee through an employee's computer graphical user interface, can prompt an employee by a voice message or e-mail message, or can otherwise generate a prompt for an employee, and can monitor the appropriate medium for a response to the prompt. For example, verification system 112 can create a graphical user interface screen that requests the employee to make suitable indications such as by selecting a user selectable graphical user interface button to indicate that the employee is present. Likewise, verification system 112 can instruct the employee to use biometric data sensor 104 to generate biometric data, or other suitable processes can be used. If verification is not received, verification system 112 can wait a predetermined period of time and prompt the employee again, can generate a notification to the employer for transmission through notification system 110, or can perform other suitable processes.

Employee warning system 114 generates warnings for employees when they deviate from schedules, when they have been late more than a predetermined number of times, when they have missed work more than a predetermined number of times, or on other suitable occasions. In one exemplary embodiment, employee warning system 114 generates notification data for transmission to the employee when the employee is late, such as to call them via telephone, send an e-mail message, send a pager notification, or otherwise transmit a warning to the employee notifying them that they are currently late and need to check in through biometric data sensor 104. Likewise, employee warning system 114 can generate a warning for an employee when the employee has been late more than a predetermined number of grace period times for being late, when the employee has missed work and has not provided a suitable excuse, or in other suitable circumstances.

In operation, system 100 allows an employer to be notified of the presence and status of employees, so as to allow the employer to attend to matters off site from a business location but to also maintain supervisory control over employees so as to know whether they are present and working. System 100 allows employee behavior to be tracked and monitored so as to ensure that employees that are habitually late, missing from their desk, absent, or otherwise not performing can be identified, notified, and terminated if necessary in response to continued improper behavior.

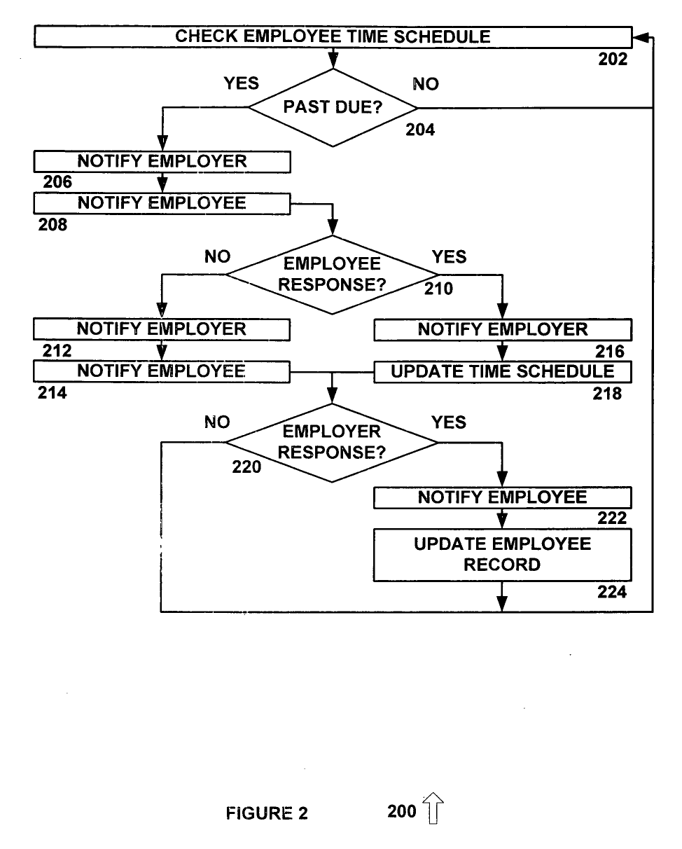

FIG. 2 is a flowchart of a method 200 for monitoring employees in accordance with an exemplary embodiment of the present invention. Method 200 begins at 202 where an employee time schedule is checked. In one exemplary embodiment, the employee time schedule can be periodically checked, such as on a 1-minute basis, and employees that should be present can be identified. The method then proceeds to 204.

At 204 it is determined whether an employee is past due. For example, if the employee schedule is checked and indicates that an employee should be present, a database can be checked that indicates whether the employee has checked in or otherwise obtained a valid excuse for being absent or late. The method then proceeds to 204. At 204 if it is determined that the employee is not past due the method returns to 202 where the employee time schedule continues to be checked. Otherwise, if an employee is determined to be past due the method proceeds to 206 where the employer is notified. As previously discussed, the employer may be notified by transmission of an e-mail message, by phone message, by pager message, or by other suitable processes. The method then proceeds to 208.

At 208 the employee is notified that they are past due in attending work. For example, an employee may be contacted via a telephone, a pager, e-mail or other suitable means, so as to allow the employee to confirm whether they are at work and may have been distracted or prevented from checking in, or to allow the employee to identify why they are not at work (e.g. medical emergency). The method then proceeds to 210.

At 210 it is determined whether an employee response has been received. If no employee response has been received the method proceeds to 212 where the employer is notified that no employee response has been received. The method then proceeds to 214 where the employee is again notified and a response is requested. The method then proceeds to 220.

Likewise, if the employee responds at 210 then the method proceeds to 216 where the employer is notified of the response. The method then proceeds to 218 where a time schedule is updated indicating that the employee did respond and what the employee's response was. The method then proceeds to 220.

At 220 it is determined whether an employer response is generated in response to the notification or non-notification by the employee to the employer of their being past due for arrival at work. If no employer response is generated the method returns to 202. Otherwise, the method proceeds to 222 where the employee is notified of the employee's response. For example, if an employee has responded and indicated that they are late for work due to a medical emergency, the employer may respond by allowing the employee to take a predetermined amount of time off to attend to the medical emergency. Likewise, other suitable employer responses can be transmitted to the employee. The method then proceeds to 224 where the employee record is updated. For example, if an employee is late arriving at work and the tardiness is excused, the employee record can be updated to reflect that the employee was late but was excused. Likewise, the employee record can be updated to indicate that the employee failed to respond after repeated warnings or other suitable information can be provided. The method then returns to 202 where additional employee time schedules can be monitored.

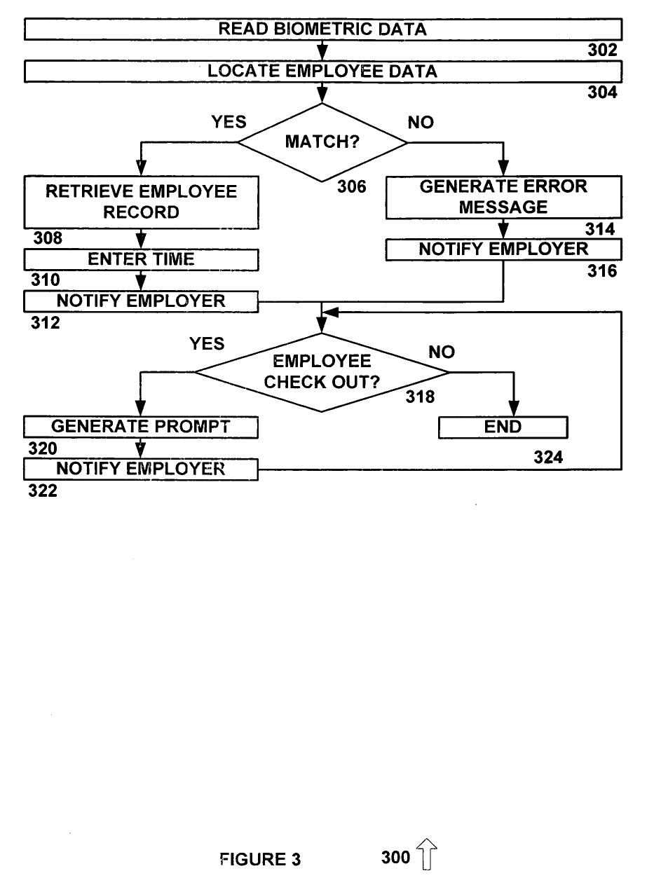

FIG. 3 is a diagram of a system 300 for monitoring employee attendance in accordance with an exemplary embodiment of the present invention. Method 300 begins at 302 where biometric data is read. In one exemplary embodiment, the biometric data can be read using a fingerprint scanner, retinal scanner, by taking a voice sample, or otherwise obtaining an indication from a person that can be verified against a database of previously stored biometric data. The method proceeds to 304.

At 304 the employee data is located for the biometric data read at 302. For example, the biometric data can be characterized by predetermined tags or identifiers that can be used to search through a database of employee biometric data. After the employee data is searched the method proceeds to 306.

At 306, it is determined whether a match exists between the biometric data read at 302. If a match does exist the method proceeds to 308 where the employee record is retrieved. For example, the employee record can include one or more files that are used to store employee attendance, absences, arrival and departure times, or other suitable employee data. The method then proceeds to 310 where the measured time of the reading of the biometric data is stored. The method then proceeds to 312 where the employer is notified, such as by generating a suitable message, telephone call, or any other suitable matters. The method then proceeds to 318.

If it is determined that 306 in that a match does not exist then the method proceeds to 314 where an error message is generated. In one exemplary embodiment, the error message can indicate that an employee has tried to check in that is not present in the database for employees. Likewise, the error message can request the employee to reenter the biometric data or to perform other suitable actions. The method then proceeds to 316 where the employer is notified of the attempt for a non-registered employee to sign in. The method then proceeds to 318.

At 318 it is determined whether an employee has checked out from the job. If an employee has checked out the method proceeds to 324 and monitoring terminates. Otherwise, the method proceeds to 320 where a prompt is generated to request the employee to verify that they are still present at work. For example, the prompt can include a graphic user interface screen, an e-mail message, a voicemail message or other suitable messages that requests the employee to confirm that they are still present at work. The method then proceeds to, 322 where the employer is notified. For example, the employer can be notified if the employee does not respond to the prompt within a predetermined amount of time, if the employee does not respond to a predetermined number of prompts over a predetermined period of time, or in other suitable manners. The method then returns to 324. Likewise, if the employer response is received at 330 the method returns to 318 for continuous monitoring of the employee.

In operation, method 300 allows an employer to be notified when an employee is present on the job, and also to communicate information to the employee such as chores that need to be given priority. Method 300 thus allows the presence of employees to be continuously monitored to ensure that employees are not checking in and then going home or leaving for long periods of time, or otherwise committing time fraud.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An apparatus for monitoring employees comprising:
a biometric sensor generating biometric data and time of measurement data;
an identification system receiving the biometric data and determining a personal identifier based on the biometric data;
an employer notification system generating a notification message including the personal identifier and the time of measurement data; and
a notification message transmission system determining an address for the notification message based on an employer notification profile.

2. The apparatus of claim 1 further comprising an employee warning system receiving the personal identifier and the time of measurement data and generating an employee warning if the time of measurement is at a time later than a reporting time associated with the personal identifier.

3. The apparatus of claim 1 further comprising an employee schedule system receiving the personal identifier and the time of measurement data and storing the personal identifier and the time of measurement data in an employee record.

4. The apparatus of claim 1 further comprising a verification system periodically generating a prompt for the employee to verify that they are present by using the biometric sensor.

5. The apparatus of claim 4 wherein the employer notification system generates a verification notification message if the employee does not respond to the verification system prompt.

6. A method for monitoring employees comprising:
generating biometric data and time of measurement data;
determining a personal identifier based on the biometric data;
generating a notification message including the personal identifier and the time of measurement data; and
determining an address for the notification message based on an employer notification profile.

7. The method of claim 6 further comprising generating an employee warning message notifying the employee that they are late checking in.

8. The method of claim 6 further comprising:
prompting the employee to enter a reason for being late; and
transmitting the reason entered by the employee to the employer.

9. The method of claim 8 further comprising receiving a response code from the employer indicating whether the reason for being late is accepted or rejected.

10. The method of 6 further comprising periodically generating an employee prompt for the employee to verify that they are present.

11. The method of claim 10 further comprising generating an employer notification if the employee does not respond to the employee prompt.

12. An apparatus for monitoring employees comprising:
biometric sensor means for generating biometric data and time of measurement data;
identification system means for determining a personal identifier based on the biometric data;
employer notification means for generating a notification message including the personal identifier and the time of measurement data; and
notification message means for determining an address for the notification message based on an employer notification profile.

13. The apparatus of claim 12 further comprising employee warning means for generating an employee warning if the time of measurement is at a time later than a reporting time associated with the personal identifier.

14. The apparatus of claim 12 further comprising employee schedule means for storing the personal identifier and the time of measurement data in an employee record.

15. The apparatus of claim 12 further comprising verification system means for periodically generating a prompt for the employee to verify that they are present by using the biometric sensor.

16. The apparatus of claim 15 wherein the employer notification means generates a verification notification message if the employee does not respond to the verification system prompt.
